(19) United States
(12) Patent Application Publication
(10) Pub. No.: US 2024/0414633 A1
(43) Pub. Date: Dec. 12, 2024

(54) DISCOVERY AND ACCESS TO LOCALIZED SERVICES

(71) Applicant: Nokia Technologies Oy, Espoo (FI)

(72) Inventors: Devaki Chandramouli, Plano, TX (US); Markus Staufer, Munich (DE); Rainer Liebhart, Munich (DE); Sumesh Parameswaran Nair, Kerala (IN); Jürgen Merkel, Renningen (DE)

(21) Appl. No.: 18/696,895

(22) PCT Filed: Sep. 29, 2022
(86) PCT No.: PCT/EP2022/077149

§ 371 Date: Mar. 28, 2024

(30) Foreign Application Priority Data
Oct. 4, 2021 (IN) 202141044954

(51) Int. Cl. H04W 48/10; H04W 36/00; H04W 36/14; H04W 60/04

(52) U.S. Cl. CPC H04W 48/10; H04W 36/033; H04W 36/14; H04W 60/04

(57) ABSTRACT

Methods, systems, apparatuses, and computer program products are provided for discovery and/or access to localized services provided by a communication network. In this regard, based on a tracking area code associated with a local network configured to provide localized services, a registration update process, a handover, or a state transition is initiated with respect to user equipment that is served by a mobile network. Furthermore, network information for the local network during the registration update process, during the handover, or during the state transition of the user equipment is determined. Network information is also provided to the user equipment during the registration update process, during the handover, or during the state transition of the user equipment. Additionally, a connection between the user equipment and the local network is established based on the network information.

### CROSS-REFERENCE TO RELATED APPLICATIONS

This application claims priority to Indian patent application No. 202141044954, filed Oct. 4, 2021, the entire contents of which are incorporated herein by reference.

### TECHNOLOGICAL FIELD

An example embodiment of the present disclosure generally relates to communication systems and, more particularly, to discovery and/or access to localized services provided by a communication network.

### BACKGROUND

Fourth generation (4G) wireless mobile telecommunications technology, also known as Long Term Evolution (LTE) technology, was designed to provide high capacity mobile multimedia with high data rates particularly for human interaction. Next generation or fifth generation (5G) technology is intended to be used not only for human interaction, but also for machine type communications in so-called Internet of Things (IoT) networks. Third generation partnership project (3GPP) 5G technology is a next generation of radio systems and network architecture that can deliver extreme broadband and ultra-robust, low latency connectivity.

### BRIEF SUMMARY

Methods, apparatuses and computer program products are provided in accordance with example embodiments to provide for discovery and/or access to localized services provided by a communication network.

In an example embodiment, a method is provided. The method includes initiating, based on a tracking area code associated with a local network configured to provide localized services, a registration update process, a handover, or a state transition with respect to user equipment that is served by a mobile network. The method also includes determining network information for the local network during the registration update process, during the handover, or during the state transition of the user equipment. The method also includes providing network information to the user equipment during the registration update process, during the handover or during the state transition of the user equipment. Additionally, the method includes establishing a connection between the user equipment and the local network based on the network information.

In an example embodiment, the determining the network information comprises determining a group identifier for network selection (GIN) for the local network. In another example embodiment, the determining the network information comprises determining a Standalone Non-Public Network (SNPN) identifier for the local network. In another example embodiment, the determining the network information comprises determining a Public Land Mobile Network (PLMN) identifier for the local network. In another example embodiment, the determining the network information comprises determining a single network slice selection assistance information (S-NSSAI) for the local network. In another example embodiment, the determining the network information comprises determining a Non-3GPP Interworking Function (N3IWF) of the local network. In another example embodiment, the determining the network information comprises determining a link to a network portal for the local network.

In an example embodiment, the establishing the connection comprises establishing, based on the network information, a direct connection between the user equipment and the local network. In another example embodiment, the establishing the connection comprises establishing, based on the network information, the connection between the user equipment and the local network via a NWu reference point between the user equipment and an N3IWF of the local network. In another example embodiment, the establishing the connection comprises establishing the connection between the user equipment and the local network in addition to another connection between the user equipment and a mobile network.

In an example embodiment, the method further includes initiating a packet data unit (PDU) session within the local network based on the network information.

In an example embodiment, the method further includes displaying the network information via a display of the user equipment. Additionally, in an example embodiment, the method further includes, based on the displaying of the network information via the display of the user equipment, selecting the local network for the connection between the user equipment and the local network.

In an example embodiment, the method further includes selecting the local network for the connection between the user equipment and the local network based on information broadcasted by the mobile network.

In an example embodiment, the method further includes selecting the local network for the connection between the user equipment and the local network based on a GIN that is mapped to the local network.

In an example embodiment, the method further includes selecting the local network for the connection between the user equipment and the local network based on the GIN and an additional indicator broadcasted by the mobile network serving the user equipment.

In an example embodiment, the method further includes performing registration of the user equipment in the local network based on an onboarding feature via a NWu reference point between the user equipment and an N3IWF of the local network.

In another example embodiment, an apparatus is provided. The apparatus comprises processing circuitry and at least one memory including computer program code instructions. The computer program code instructions are configured to, when executed by the processing circuitry, cause the apparatus to initiate, based on a tracking area code associated with a local network configured to provide localized services, a registration update process, a handover, or a state transition with respect to user equipment that is served by a mobile network. The computer program code instructions are further configured to, when executed by the processing circuitry, cause the apparatus to determine network information for the local network during the registration update process, during the handover, or during the state transition of the user equipment. The computer program code instructions are further configured to, when executed by the processing circuitry, cause the apparatus to provide network information to the user equipment during the registration update process, during the handover, or during the state transition of the user equipment. The computer program code instructions are further configured to, when executed by the processing circuitry, cause the apparatus to establish a connection between the user equipment and the local network based on the network information.

In an example embodiment, the computer program code instructions are further configured to, when executed by the processing circuitry, cause the apparatus to determine a GIN for the local network based on the registration update process. In another example embodiment, the computer program code instructions are further configured to, when executed by the processing circuitry, cause the apparatus to determine a SNPN identifier for the local network based on the registration update process. In another example embodiment, the computer program code instructions are further configured to, when executed by the processing circuitry, cause the apparatus to determine a PLMN identifier for the local network based on the registration update process. In another example embodiment, the computer program code instructions are further configured to, when executed by the processing circuitry, cause the apparatus to determine a S-NSSAI for the local network based on the registration update process. In another example embodiment, the computer program code instructions are further configured to, when executed by the processing circuitry, cause the apparatus to determine an N3IWF for the local network based on the registration update process. In another example embodiment, the computer program code instructions are further configured to, when executed by the processing circuitry, cause the apparatus to determine a link to a network portal for the local network based on the registration update process.

In another example embodiment, the computer program code instructions are further configured to, when executed by the processing circuitry, cause the apparatus to establish, based on the network information, a direct connection between the user equipment and the local network. In another example embodiment, the computer program code instructions are further configured to, when executed by the processing circuitry, cause the apparatus to establish, based on the network information, the connection between the user equipment and the local network via a NWu reference point between the user equipment and an N3IWF of the local network. In another example embodiment, the computer program code instructions are further configured to, when executed by the processing circuitry, cause the apparatus to establish the connection between the user equipment and the local network in addition to another connection between the user equipment and a mobile network.

In another example embodiment, the computer program code instructions are further configured to, when executed by the processing circuitry, cause the apparatus to initiate a PDU session within the local network based on the network information.

In another example embodiment, the computer program code instructions are further configured to, when executed by the processing circuitry, cause the apparatus to display the network information via a display of the user equipment. Additionally, in an example embodiment, the computer program code instructions are further configured to, when executed by the processing circuitry, cause the apparatus to select the local network for the connection between the user equipment and the local network based on the display of the network information via the display of the user equipment.

In another example embodiment, the computer program code instructions are further configured to, when executed by the processing circuitry, cause the apparatus to select the local network for the connection between the user equipment and the local network based on information broadcasted by the mobile network.

In another example embodiment, the computer program code instructions are further configured to, when executed by the processing circuitry, cause the apparatus to select the local network for the connection between the user equipment and the local network based on a GIN that is mapped to the local network.

In another example embodiment, the computer program code instructions are further configured to, when executed by the processing circuitry, cause the apparatus to select the local network for the connection between the user equipment and the local network based on the GIN and an additional indicator broadcasted by the mobile network serving the user equipment.

In another example embodiment, the computer program code instructions are further configured to, when executed by the processing circuitry, cause the apparatus to perform registration of the user equipment in the local network based on an onboarding feature via a NWu reference point between the user equipment and an N3IWF of the local network.

In yet another example embodiment, a computer program product is provided. The computer program product comprises at least one non-transitory computer-readable storage medium having computer-executable program code instructions stored therein. The computer-executable program code instructions comprise program code instructions to initiate, based on a tracking area code associated with a local network configured to provide localized services, a registration update process, a handover, or a state transition with respect to user equipment that is served by a mobile network. The computer-executable program code instructions also comprise program code instructions to determine network information for the local network during the registration update process, during the handover, or during the state transition of the user equipment. The computer-executable program code instructions also comprise program code instructions to provide network information to the user equipment during the registration update process, during the handover, or during the state transition of the user equipment. The computer-executable program code instructions also comprise program code instructions to establish a connection between the user equipment and the local network based on the network information.

In an example embodiment, the computer-executable program code instructions further comprise program code instructions to determine a GIN for the local network based on the registration update process. In another example embodiment, the computer-executable program code instructions also comprise program code instructions to determine an SNPN identifier for the local network based on the registration update process. In another example embodiment, the computer-executable program code instructions also comprise program code instructions to determine a PLMN identifier for the local network based on the registration update process. In another example embodiment, the computer-executable program code instructions also comprise program code instructions to determine an S-NSSAI for the local network based on the registration update process. In another example embodiment, the computer-executable program code instructions also comprise program code instructions to determine an N3IWF for the local network based on the registration update process. In another example embodiment, the computer-executable program code instructions also comprise program code instructions to determine a link to a network portal for the local network based on the registration update process.

In an example embodiment, the computer-executable program code instructions also comprise program code instructions to establish, based on the network information, a direct connection between the user equipment and the local network. In another example embodiment, the computer-executable program code instructions also comprise program code instructions to establish, based on the network information, the connection between the user equipment and the local network via a NWu reference point between the user equipment and an N3IWF of the local network. In another example embodiment, the computer-executable program code instructions also comprise program code instructions to establish the connection between the user equipment and the local network in addition to another connection between the user equipment and a mobile network

In an example embodiment, the computer-executable program code instructions also comprise program code instructions to initiate a PDU session within the local network based on the network information.

In an example embodiment, the computer-executable program code instructions also comprise program code instructions to display the network information via a display of the user equipment. Additionally, in an example embodiment, the computer-executable program code instructions also comprise program code instructions to select the local network for the connection between the user equipment and the local network based on the display of the network information via the display of the user equipment.

In an example embodiment, the computer-executable program code instructions also comprise program code instructions to select the local network for the connection between the user equipment and the local network based on information broadcasted by the mobile network.

In another example embodiment, the computer-executable program code instructions also comprise program code instructions to select the local network for the connection between the user equipment and the local network based on a GIN that is mapped to the local network.

In another example embodiment, the computer-executable program code instructions also comprise program code instructions to select the local network for the connection between the user equipment and the local network based on the GIN and an additional indicator broadcasted by the mobile network serving the user equipment.

In another example embodiment, the computer-executable program code instructions also comprise program code instructions to perform registration of the user equipment in the local network based on an onboarding feature via a NWu reference point between the user equipment and an N3IWF of the local network.

### BRIEF DESCRIPTION OF THE DRAWINGS

Having thus described certain example embodiments of the invention in general terms, reference will now be made to the accompanying drawings, which are not necessarily drawn to scale, and wherein:

FIG. 1 depicts an example system environment in which implementations in accordance with one or more example embodiments of the present disclosure;

FIG. 2 depicts an example serving network in accordance with one or more example embodiments of the present disclosure;

FIG. 3 depicts an example Providing Access to Localized Services (PALS) network in accordance with one or more example embodiments of the present disclosure;

FIG. 4 is a block diagram of an apparatus configured in accordance with one or more example embodiments of the present disclosure;

FIG. 5 illustrates example transmissions between user equipment, a serving network and a PALS network in accordance with one or more example embodiments of the present disclosure;

FIG. 6 illustrates other example transmissions between user equipment, a serving network and a PALS network in accordance with one or more example embodiments of the present disclosure;

FIG. 7 illustrates other example transmissions between user equipment, a serving network and a PALS network in accordance with one or more example embodiments of the present disclosure;

FIG. 8 illustrates other example transmissions between user equipment, a serving network and a PALS network in accordance with one or more example embodiments of the present disclosure;

FIG. 9 illustrates other example transmissions between user equipment, a serving network and a PALS network in accordance with one or more example embodiments of the present disclosure; and

FIG. 10 illustrates a flowchart illustrating operations performed, such as by the apparatus of FIG. 4, in order to provide discovery and/or access to localized services provided by a communication network, in accordance with one or more example embodiments of the present disclosure.

### DETAILED DESCRIPTION

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As defined herein, a “computer-readable storage medium,” which refers to a physical storage medium (e.g., volatile or non-volatile memory device), may be differentiated from a “computer-readable transmission medium,” which refers to an electromagnetic signal.

Third generation partnership project (3GPP) 5th generation (5G) technology is a next generation of radio systems and network architecture that can deliver extreme broadband and ultra-robust, low latency connectivity. 5G technology improves a variety of telecommunication services offered to the end users, and helps to support massive broadband that delivers gigabytes of bandwidth per second on demand for both the uplink and downlink transmissions.

Embodiments will be illustrated herein in conjunction with example communication systems and associated techniques for discovery and/or access to localized services. It should be understood, however, that the scope of the claims is not limited to particular types of communication systems and/or processes disclosed. Embodiments can be implemented in a wide variety of other types of communication systems, using alternative processes and operations. For example, although illustrated in the context of wireless cellular systems utilizing 3GPP system elements such as a 3GPP next generation system (5G), the disclosed embodiments can be adapted in a straightforward manner to a variety of other types of communication systems.

In accordance with illustrative embodiments implemented in a 5G communication system environment, one or more 3GPP technical specifications (TS) and technical reports (TR) provide further explanation of user equipment and network elements/functions and/or operations that interact with one or more illustrative embodiments, e.g., 3GPP TR 22.844, 3GPP TS 23.501, 3GPP TS 23.502, etc. Other 3GPP TS/TR documents provide other conventional details that one of ordinary skill in the art will realize. However, while illustrative embodiments are well-suited for implementation associated with the above-mentioned 5G-related 3GPP standards, alternative embodiments are not necessarily intended to be limited to any particular standards.

According to current network discovery and/or access techniques, user equipment can perform cell selection for a network based on radio conditions. Additionally, user equipment can determine services information broadcasted over the radio interface prior to performing network selection. However, user equipment as configured for current network discovery and/or access techniques is unable to employ Group IDs for Network selection (GIN). Furthermore, GIN is generally not available for employment by certain networks such as, for example, a public land mobile network. Moreover, while employing a network, user equipment is generally unable to determine services offered by another network.

As such, described herein are methods, apparatuses, and computer program products for discovery and/or access to localized services provided by a communication network to resolve some or all of the described limitations of the current relevant standards, and/or other limitations of the current relevant standards. Such methods, apparatuses, and computer program products are thus described that provide improved accessibility and/or selection of local services associated with a communication network for user equipment. Furthermore, a number of computing resources and/or processing tasks for user equipment to access a communication network and/or employ local services for the communication network can be reduced. Efficiency and/or network connectivity for a communication network can also be improved. For example, overall network signaling can be reduced to provide improved resiliency, security, network latency, and/or network speeds provided by a communication network. Moreover, methods, apparatuses, and computer program products disclosed herein can enable user equipment to access a hosting network with no prior subscription to the hosting network and/or to a third-party provider associated with the hosting network (e.g., to employ localized services via the hosting network).

In one or more embodiments, methods, apparatuses, and computer program products disclosed herein allow user equipment to discover and/or employ services offered by a Providing Access to Localized Services (PALS) network. Furthermore, in one or more embodiments, the user equipment can access the PALS network while also being concurrently registered in another network, (e.g., a Home PLMN (HPLMN) or Visited PLMN (VPLMN)). In certain embodiments, the user equipment can be redirected to a PALS network portal. In certain embodiments, a user equipment configuration update (UCU) can be employed to provide PALS network information. In certain embodiments, a GIN (or any other parameter) can be mapped to PALS network and/or can be broadcasted by a serving network to indicate availability of one or more services provided by the PALS network. In certain embodiments, onboarding in the PALS network can be provided via an underlay network (e.g., using NWu). In certain embodiments, detection of a PALS network can be provided during connected mobility.

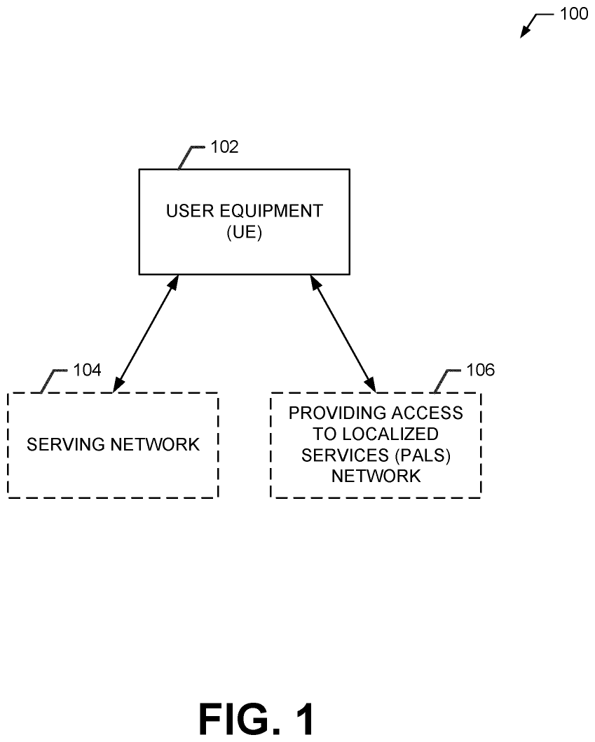

FIG. 1 depicts an example communication system environment in which implementations in accordance with an example embodiment of the present disclosure may be performed. The depiction of system environment 100 in FIG. 1 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1, and the system environment 100 disclosed therein is merely presented to provide an example basis and context for the facilitation of some of the features, aspects, and uses of the methods, apparatuses, and computer program products disclosed and contemplated herein. It will be understood that while many of the aspects and components presented in FIG. 1 are shown as discrete, separate elements, other configurations may be used in connection with the methods, apparatuses, and computer programs described herein, including configurations that combine, omit, and/or add aspects and/or components.

In one or more embodiments, the system environment 100 is a network environment. As shown in FIG. 1, the system environment 100 includes user equipment (UE) 102, a serving network 104, and/or a providing access to localized services (PALS) network 106. The user equipment 102 is configured to communicate wirelessly with the serving network 104 and/or the PALS network 106. Although the user equipment 102 may be configured in a variety of different manners, the user equipment 102 may be embodied as a mobile terminal, such as a portable digital assistant (PDA), mobile phone, smartphone, pager, mobile television, gaming device, laptop computer, camera, tablet computer, communicator, pad, headset, touch surface, video recorder, audio/video player, radio, electronic book, positioning device (e.g., global positioning system (GPS) device), or any combination of the aforementioned, and other types of voice and text and multi-modal communications systems.

The serving network 104 is a mobile network. In one or more embodiments, the serving network 104 includes one or more access points, such as one or more base stations, including but not limited to node Bs, evolved Node Bs (eNB), or the like. In some embodiments, the one or more access points of the serving network 104 are one or more cellular access points. In some embodiments, the one or more access points of the serving network 104 may define and/or service one or more cells. In one or more embodiments, the serving network 104 may be a core network such that the one or more access points establish cellular radio access networks by which the user equipment 102 may communicate with the serving network 104. In one or more embodiments, the serving network 104 may include a plurality of different cellular radio access cells and/or networks or parts of such networks including, for example, a 5G radio access network, an LTE (Long-Term Evolution) radio access network, a UMTS (universal mobile telecommunications system) radio access network, etc. In some example implementations, equipment and other infrastructure associated with multiple different cellular radio access networks may be located at or near structures and/or other equipment associated with the serving network 104.

In one or more embodiments, the user equipment 102 is able to access the serving network 104 via a radio access network provided across one or more access points. Although not shown, the system environment 100 may also include a controller associated with the serving network 104, such as, base stations, for example, so as to facilitate operation of the access points and management of the user equipment 102 in communication therewith. In one or more embodiments, the serving network 104 may be one or more wireless local area networks (WLANs), each of which may be serviced by a WLAN access point configured to establish wireless communications with the user equipment 102. As such, in one or more embodiments, the user equipment 102 may communicate with the serving network 104 via a WLAN access point. In one or more embodiments, the serving network 104 may additionally or alternatively consist of additional network elements as routers, switches, servers, gateways, and/or controllers.

In one or more embodiments, the PALS network 106 is a local network configured to provide localized services (e.g., localized services for the user equipment 102 and/or one or more other user equipment) at a specific location (e.g., a specific geographic area). In one or more embodiments, the PALS network 106 is a temporary network available with a delimited network service area. In one or more embodiments, the PALS network 106 is a private network such as, for example, a standalone non-public network (SNPN). In one or more embodiments, the localized services are specialized network services configured for an interval of time and/or at a specific location (e.g., a specific geographic area). For example, the localized services can be third-party provider services configured for an interval of time and/or at a specific location (e.g., a specific geographic area). As such, the localized services and/or access to the PALS network 106 can be bounded by space and time. In one or more embodiments, the localized services are associated with network access parameters for the PALS network 106, one or more network slices for the PALS network 106, and/or one or more policies (e.g., network slice policies, connectivity policies, quality of service policies, routing policies, etc.) for the PALS network 106. In one or more embodiments, respective localized services are provided by one or more service providers via the PALS network 106. In certain embodiments, the localized services are configured using one or more blockchain technologies. In an exemplary embodiment, the localized services are configured for providing media (e.g., streaming live video, an interactive gaming environment, a streaming movie, etc.), internet access (e.g., 5G internet access), automatic access to one or more geographic locations, reply services, and/or other content to the user equipment 102. In another exemplary embodiment, the PALS network 106 is a local network at a stadium providing the localized services to end users (e.g., including the user equipment 102) for one or more events.

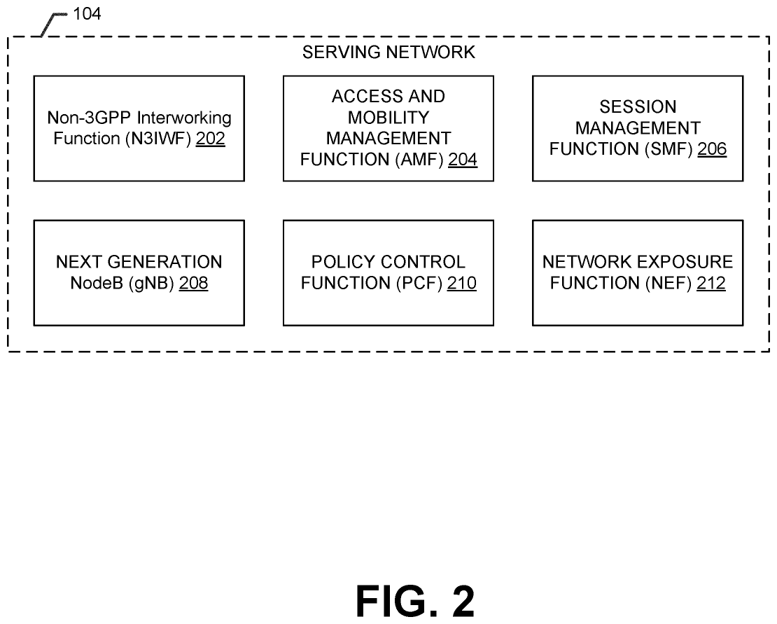

In an embodiment, the serving network 104 is configured as depicted in FIG. 2. For example, in one or more embodiments, the serving network 104 comprises one or more network functions and/or network devices such as, but not limited to, Non-3GPP Interworking Function (N3IWF) 202, Access and Mobility Management Function (AMF) 204, Session Management Function (SMF) 206, a next generation nodeB (gNB) 208, Policy Control Function (PCF) 210, and/or Network Exposure Function (NEF) 212. In one or more embodiments, the N3IWF 202 is configured for routing data associated with non-3GPP access to the serving network 104. The AMF 204 is a core network function for the serving network 104. In one or more embodiments, the AMF 204 is configured for access management associated with the serving network 104, registration management associated with the serving network 104, connection management associated with the serving network 104, security management associated with the serving network 104, authorization management associated with the serving network 104, and/or one or more other core network functions associated with the serving network 104. In one or more embodiments, the SMF 206 is configured for managing one or more subscriber sessions (e.g., establishing a subscriber session, modifying a subscriber session, releasing a subscriber session, etc.) with respect to the serving network 104. In one or more embodiments, the gNB 208 is a computing device configured to control radio resources of the serving network 104. In certain embodiments, the gNB 208 is a base station, an access point or any other type of interfacing device including a relay station capable of operating in the serving network 104. In one or more embodiments, the PCF 210 is configured to manage behavior associated with the serving network 104. For example, in one or more embodiments, the PCF 210 is configured to provide and/or manage one or more policy rules for the serving network 104. In one or more embodiments, the NEF 212 is configured to provide one or more devices (e.g., the user equipment 102), one or more other networks (e.g., the PALS network 106), and/or one or more third-party services with information related to services and/or capabilities of the serving network 104. However, it is to be appreciated that, in some embodiments, the serving network 104 additionally or alternatively includes one or more of the following network functions: Authentication Server Function (AUSF), Data Network (DN), e.g. operator services, Internet access or 3rd party services, Unstructured Data Storage Function (UDSF), Network Repository Function (NRF), Network Slice Selection Function (NSSF), Unified Data Management (UDM), Unified Data Repository (UDR), User Plane Function (UPF), UE radio Capability Management Function (UCMF), Application Function (AF), Next Generation-Radio Access Network (NG-RAN), 5G-Equipment Identity Register (5G-EIR), Network Data Analytics Function (NWDAF), and/or Charging Function (CHF).

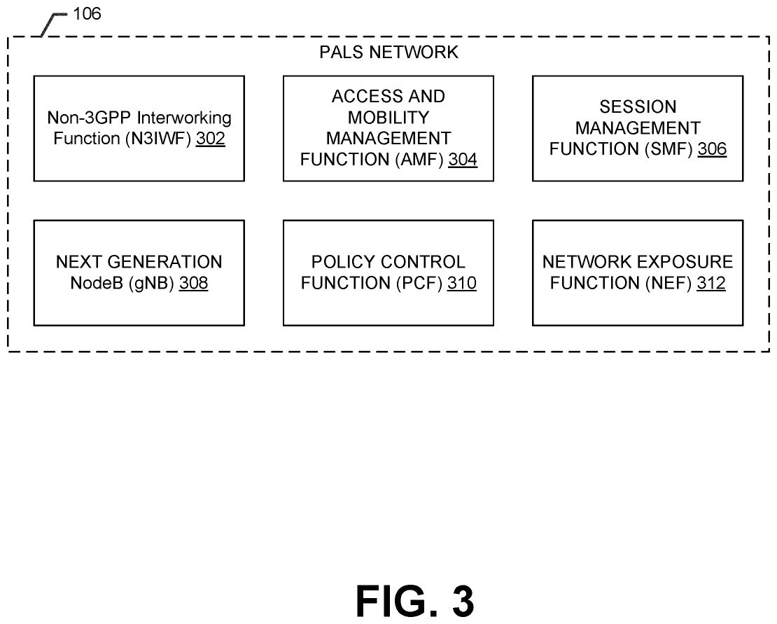

Additionally, in an embodiment, the PALS network 106 is configured as depicted in FIG. 3. For example, in one or more embodiments, the PALS network 106 comprises one or more network functions and/or network devices such as, but not limited to, Non-3GPP Interworking Function (N3IWF) 302, Access and Mobility Management Function (AMF) 304, Session Management Function (SMF) 306, a next generation nodeB (gNB) 308, Policy Control Function (PCF) 310, and/or Network Exposure Function (NEF) 312. In one or more embodiments, the N3IWF 302 is configured for routing data associated with non-3GPP access to the PALS network 106. The AMF 304 is a core network function for the PALS network 106. In one or more embodiments, the AMF 304 is configured for access management associated with the PALS network 106, registration management associated with the PALS network 106, connection management associated with the PALS network 106, security management associated with the PALS network 106, authorization management associated with the PALS network 106, and/or one or more other core network functions associated with the PALS network 106. In one or more embodiments, the SMF 306 is configured for managing one or more subscriber sessions (e.g., establishing a subscriber session, modifying a subscriber session, releasing a subscriber session, etc.) with respect to the PALS network 106. In one or more embodiments, the gNB 308 is a computing device configured to control radio resources of the PALS network 106. In certain embodiments, the gNB 308 is a base station, an access point or any other type of interfacing device including a relay station capable of operating in the PALS network 106. In one or more embodiments, the PCF 310 is configured to manage behavior associated with the PALS network 106. For example, in one or more embodiments, the PCF 310 is configured to provide and/or manage one or more policy rules for the PALS network 106. In one or more embodiments, the NEF 312 is configured to provide one or more devices (e.g., the user equipment 102), one or more other networks (e.g., the PALS network 106), and/or one or more third-party services with information related to services and/or capabilities of the PALS network 106. However, it is to be appreciated that, in some embodiments, the PALS network 106 additionally or alternatively includes one or more of the following network functions: AUSF, DN, e.g. operator services, Internet access or 3rd party services, UDSF, NRF, NSSF, UDM, UDR, UPF, UCMF, AF, NG-RAN, 5G-EIR, NWDAF, and/or CHF.

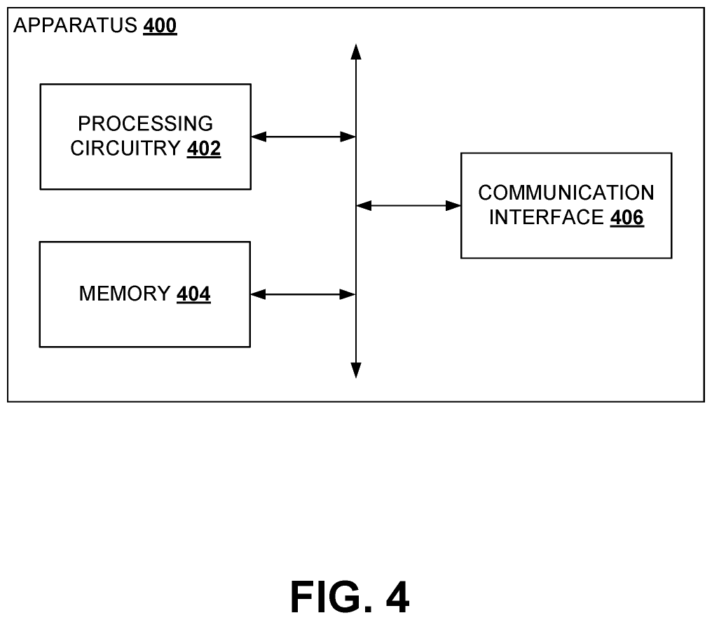

In one or more embodiments, access to localized services can be provided within the system environment 100 by employing an apparatus 400 as depicted in FIG. 4. The apparatus 400 may be embodied by and/or incorporated into one or more UEs, such as user equipment 102, or any of the other devices discussed with respect to FIG. 1, such as an access point and/or another device incorporated or otherwise associated with the serving network 104 and/or the PALS network 106. Alternatively, the apparatus 400 may be embodied by another device, external to such devices. For example, the apparatus may be embodied by a computing device, such as a personal computer, a computer workstation, a server or the like, or by any of various mobile computing devices, such as a mobile terminal, including but not limited to a smartphone, a tablet computer, or the like, for example.

Regardless of the manner in which the apparatus 400 is embodied, the apparatus 400 of an example embodiment is configured to include or otherwise be in communication with a processing circuitry 402 and a memory 404. In some embodiments, the apparatus 400 is configured to additionally include or otherwise be in communication with a communication interface 406. In some embodiments, the processing circuitry 402 may be in communication with the memory 404 via a bus for passing information among components of the apparatus 400. The memory 404 may be non-transitory and may include, for example, one or more volatile and/or non-volatile memories. In other words, for example, the memory 404 may be an electronic storage device (e.g., a computer readable storage medium) comprising gates configured to store data (e.g., bits) that may be retrievable by a machine (e.g., a computing device like the processing circuitry 402). The memory 404 may be configured to store information, data, content, applications, instructions, or the like for enabling the apparatus 400 to carry out various functions in accordance with an example embodiment of the present disclosure. For example, the memory 404 could be configured to buffer input data for processing by the processing circuitry 402. Additionally or alternatively, the memory 404 could be configured to store instructions for execution by the processing circuitry 402.

As described above, the apparatus 400 may be embodied by a computing device. However, in some embodiments, the apparatus 400 may be embodied as a chip or chip set. In other words, the apparatus 400 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 400 may therefore, in some cases, be configured to implement an embodiment of the present disclosure on a single chip or as a single “system on a chip.” As such, in some cases, a chip or chipset may constitute means for performing one or more operations for providing the functionalities described herein.

The processing circuitry 402 may be embodied in a number of different ways. For example, the processing circuitry 402 may be embodied as one or more of various hardware processing means including a processor, such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry 402 may include one or more processing cores configured to perform independently. A multi-core processor may enable multiprocessing within a single physical package. Additionally or alternatively, the processing circuitry 402 may include one or more processors configured in tandem via the bus to enable independent execution of instructions, pipelining and/or multithreading.

In an example embodiment, the processing circuitry 402 may be configured to execute instructions stored in the memory 404 or otherwise accessible to the processing circuitry 402. Alternatively or additionally, the processing circuitry 402 may be configured to execute hard coded functionality. As such, whether configured by hardware or software methods, or by a combination thereof, the processing circuitry 402 may represent an entity (e.g., physically embodied in circuitry) capable of performing operations according to an embodiment of the present disclosure while configured accordingly. Thus, for example, when the processing circuitry 402 is embodied as an ASIC, FPGA or the like, the processing circuitry 402 may be specifically configured hardware for conducting the operations described herein. Alternatively, as another example, when the processing circuitry 402 is embodied as an executor of software instructions, the instructions may specifically configure the processing circuitry 402 to perform the algorithms and/or operations described herein when the instructions are executed. However, in some cases, the processing circuitry 402 may be a processor of a specific device (e.g., a pass-through display or a mobile terminal) configured to employ an embodiment of the present disclosure by further configuration of the processing circuitry 402 by instructions for performing the algorithms and/or operations described herein. The processing circuitry 402 may include, among other things, a clock, an arithmetic logic unit (ALU) and logic gates configured to support operation of the processing circuitry 402.

The apparatus 400 may optionally include the communication interface 406. The communication interface 406 may be any means such as a device or circuitry embodied in either hardware or a combination of hardware and software that is configured to receive and/or transmit data from/to a network and/or any other device or module in communication with the apparatus. In this regard, the communication interface 406 may include, for example, an antenna (or multiple antennas) and supporting hardware and/or software for enabling communications with a wireless communication network. Additionally or alternatively, the communication interface 406 may include the circuitry for interacting with the antenna(s) to cause transmission of signals via the antenna(s) or to handle receipt of signals received via the antenna(s). In some environments, the communication interface 406 may alternatively or also support wired communication. As such, for example, the communication interface 406 may include a communication modem and/or other hardware/software for supporting communication via cable, digital subscriber line (DSL), universal serial bus (USB) or other mechanisms.

Provided hereinbelow, are example transmissions between the user equipment 102, the serving network 104 and the PALS network 106. The below example transmissions provide the foreseen steps or messaging needed.

In one or more embodiments, the below example transmissions illustrate discovery services offered by the PALS network 106 to allow the user equipment 102 access to the PALS network 106. In certain embodiments, the below example transmissions illustrate discovery services offered by the PALS network 106 to allow the user equipment 102 access to the PALS network 106 while the user equipment is also registered with the serving network 104 (e.g., HPLMN or VPLMN). Note that these solution proposals impact mainly UE, gNB, AMF, SMF, PCF and UDM

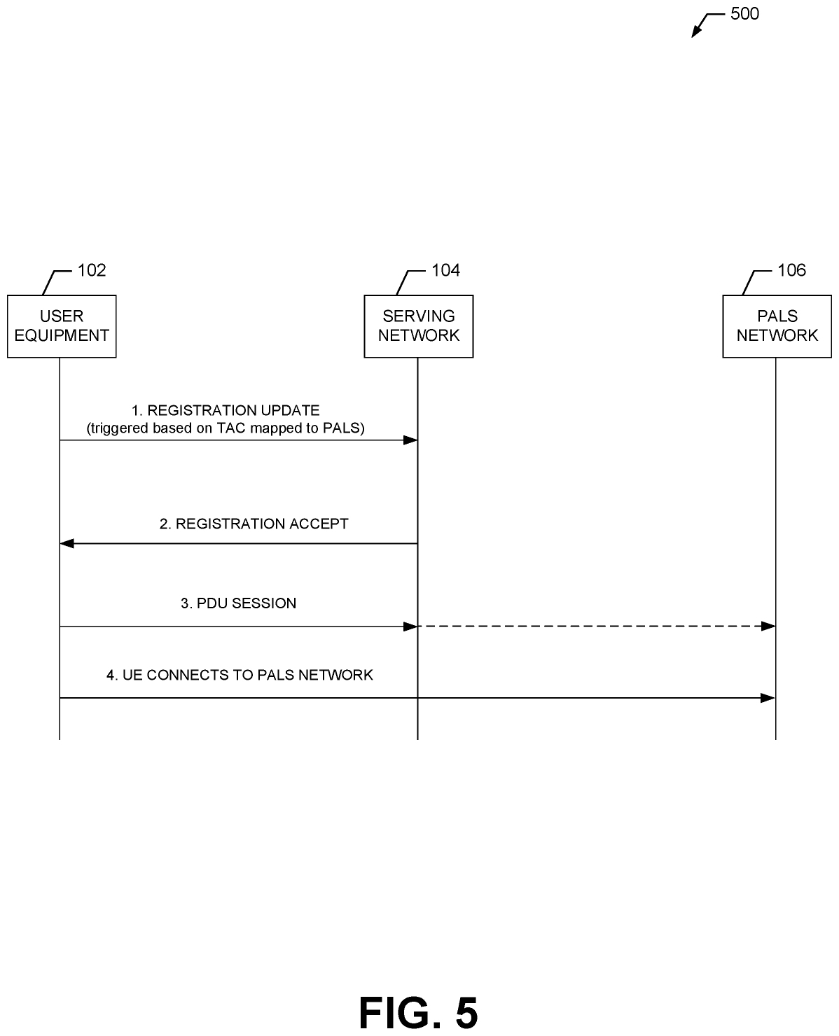

FIG. 5 illustrates example transmissions between the user equipment 102, the serving network 104 and the PALS network 106 to provide discovery and/or access to localized services associated with the PALS network 106, according to one or more embodiments. In an embodiment, the example transmissions illustrated in FIG. 5 are provided to redirect the user equipment 102 to a portal of the PALS network 106. In one or more embodiments, a location of the PALS network 106 is mapped to a tracking area, a tracking area code, a cell identifier, and/or coordinates. In one or more embodiments, a registration area list is assigned to the user equipment 102 such that the user equipment 102 performs a registration area update when the tracking area changes. In an embodiment, one or more portions of the tracking area can overlap with an area of the PALS network 106. In another embodiment, the tracking area can be distinct with respect to an area of the PALS network 106. In one or more embodiments, a registration update to the serving network 104 is performed in response to the user equipment 102 entering the corresponding tracking area. In certain embodiments, if the tracking area is larger than an area of the PALS network 106 and the PALS network 106 is not available when the user equipment 102 receives a user equipment configuration update with PALS network information, the user equipment 102 may periodically scan for presence of the PALS network 106 and connect to the PALS network 106 once connectivity to the PALS network 106 becomes available. In certain embodiments, the user equipment 102 can continue scanning (e.g., repeatedly scan) for existence of the PALS network 106 until a next registration update. Alternatively, in certain embodiments, the user equipment 102 can continue scanning (e.g., repeatedly scan) for existence of the PALS network 106 until the user equipment 102 receives updated PALS related information from the serving network 104 via a user equipment configuration update or a steering of roaming process. Alternatively, in certain embodiments, the user equipment 102 can continue scanning (e.g., repeatedly scan) for existence of the PALS network 106 until the user equipment 102 deregisters from the service network 104 or until a timer associated with the user equipment 102 reaches a predetermined threshold level (e.g., the timer expires).

In an embodiment, the user equipment 102 can send a REGISTRATION UPDATE message to the serving network 104, at 1. The REGISTRATION UPDATE message can be triggered based on one or more changes to the tracking area and/or the tracking area code. In one or more embodiments, the REGISTRATION UPDATE message is generated in response a tracking area code for the user equipment 102 satisfying a defined criterion associated with a mapping between the tracking area code and the PALS network 106 configured to provide localized services. In one or more embodiments, the serving network 104 can detect that the user equipment 102 has moved to a tracking area where PALS service for the PALS network 106 is offered based on the REGISTRATION UPDATE message trigged by the User Equipment 102.

Additionally, the serving network 104, or another suitable network entity of the communication system, can send a REGISTRATION ACCEPT message to the user equipment 102, at 2. The REGISTRATION ACCEPT message can include network information (e.g., PALS network information) for the PALS network 106. In an embodiment, the network information for the PALS network 106 can be generated in response to a registration update process performed by the serving network 104 and provided to the user equipment 102. In another embodiment, the network information for the PALS network 106 can be provided via UCU by the serving network 104. In another embodiment, the network information for the PALS network 106 can be provided via steering of roaming (SoR) by the serving network 104. The network information (e.g., PALS network information) for the PALS network 106 can be configured to provide information regarding the PALS network 106 to allow the user equipment 102 to obtain connectivity with respect to a PALS network portal of the PALS network 106. In an embodiment, the network information (e.g., PALS network information) for the PALS network 106 includes a Standalone Non-Public Network (SNPN) identifier for the PALS network 106. Additionally or alternatively, the network information (e.g., PALS network information) for the PALS network 106 includes a Public Land Mobile Network (PLMN) identifier for the PALS network 106. Additionally or alternatively, the network information (e.g., PALS network information) for the PALS network 106 includes a data network name (DNN) used by the PALS network 106. Additionally or alternatively, the network information (e.g., PALS network information) for the PALS network 106 includes a single network slice selection assistance information (S-NSSAI) used by the PALS network 106. Additionally or alternatively, the network information (e.g., PALS network information) for the PALS network 106 includes a link to a network portal (e.g., a PALS network portal) used by the PALS network 106. In an embodiment, the link can be a uniform resource locator (URL) link associated with the network portal.

At 3, the user equipment 102 can send a PDU SESSION message to the serving network 104 to access the PALS network 106. In an embodiment, the user equipment 102 can send the PDU SESSION message to the serving network 104 and the serving network 104 can forward the PDU SESSION message to the PALS network 106. In certain embodiments, the serving network 104 can redirect traffic from the user equipment 102 to a PALS network portal of the PALS network 106 using one or more policies, one or more policy detection rules, and/or one or more forward action rules in the serving network 104 and/or in the PALS network 106. In one or more embodiments, the user equipment 102 initiates a PDU session and/or a PDU session update (e.g., a PDU session and/or a PDU session update with respect to the PALS network 106) via the PDU SESSION message. The PDU session can be configured to transmit IP traffic data. In certain embodiments, the user equipment 102 can be configured to access the PALS network portal of the PALS network 106 to facilitate the PDU session. In certain embodiments, the user equipment 102 can be redirected to the PALS network portal of the PALS network 106 to facilitate the PDU session. In one or more embodiments, the user equipment 102 can employ an internet PDU session, reactivate a PDU session, and/or employ a link provided by the serving network 104 (e.g., a link included in one or more protocol configuration options) to transmit traffic via the PDU session to the PALS network 106. In one or more embodiments, the user equipment 102 generates the PDU SESSION message (e.g., initiates the PDU session and/or a PDU session update) using the network information (e.g., PALS network information) for the PALS network 106. For example, in one or more embodiments, the user equipment 102 generates the PDU SESSION message (e.g., initiates the PDU session and/or a PDU session update with the serving network 104) using the DNN, the S-NSSAI, the SNPN ID, the PLMN ID, and/or other network information associated with the PALS network 106. Furthermore, the serving network 104 redirects a UE session associated with the user equipment 102 to the PALS network 106 (e.g., to the PALS network portal of the PALS network 106). In another embodiment, the user equipment 102 can send the PDU SESSION message directly to the PALS network 106. For example, in some embodiments, the user equipment 102 can establish a PDU session with the serving network 104 and can further access a URL of the PALS network 106.

Additionally, the user equipment 102 can connect to the PALS network 106, at 4. For example, the user equipment 102 can establish a connection between the user equipment 102 and the PALS network. In one or more embodiments, the user equipment 102 can connect to the PALS network 106 based on connectivity information, one or more subscriptions, and/or one or more authorizations obtained for, and/or provided by, the PALS network 106. In an embodiment, the user equipment 102 can connect to the PALS network 106 via a direct connection between the user equipment 102 and the PALS network 106. In another embodiment, the user equipment 102 can connect to the PALS network 106 via a NWu reference point between the user equipment 102 and a N3IWF of the PALS network 106 (e.g., via NWu connectivity). In certain embodiments, the user equipment 102 can connect to the PALS network 106 based on a N3IWF address of the PALS network 106.

In one or more embodiments, the user equipment 102 is redirected to a PALS network portal of the PALS network 106. For example, when the user equipment is employing the serving network 104 (e.g., HPLMN or VPLMN), the serving network 104 can detect the location (e.g., tracking area, Cell ID, global positioning system coordinates, etc.) of the user equipment. Furthermore, in response to a determination that the user equipment 102 is in a vicinity of the PALS network 106, the serving network 104 can provide the network information (e.g., a URL or other data) to connect to a PALS portal page of the PALS network 106. In an embodiment, the network information can be provided to the user equipment using one or more protocol configuration options, UCU and/or SoR. In certain embodiments, based on one or more user preference for a user identifier associated with the user equipment 102, the user equipment can subscribe to the PALS network 106 via the PALS portal (e.g., identified by URL, etc.) and can connect to the PALS network 106.

In one or more embodiments, a UCU can be employed to provide the network information for the PALS network 106. For example, when the user equipment is employing the serving network 104 (e.g., HPLMN or VPLMN), the serving network 104 can detect the location (e.g., tracking area, Cell ID, global positioning system coordinates, etc.) of the user equipment. The serving network 104 can also provide information regarding available PALS networks (e.g., PLMN ID, SNPN ID, etc.) in a given area associated with the user equipment 102 using UCU process. In certain embodiments, the serving network 104 can provide the information regarding the PALS network 106 directly to the user equipment when the user equipment 102 enters an area associated with the PALS network 106. Alternatively, in certain embodiments, the serving network 14 can establish one or more agreements with the PALS network 106 to provide the network information to the UE via SoR. In one or more embodiments, the user equipment 102 can select and/or access the PALS network 106 directly using the received information. Alternatively, the user equipment 102 can connect from the serving network 104 to PALS network 106 via NWu interface to a N3IWF located in the PALS network 106. An N3IWF address of the N3IWF located in the PALS network 106 and/or one or more credentials to access the PALS network 106 can also be configured via UCU or SoR on the user equipment 102. The one or more credentials can be specific to the user equipment 102 and/or can be usable by one or more other user equipment (e.g., one or more other user equipment serviced by the serving network 104).

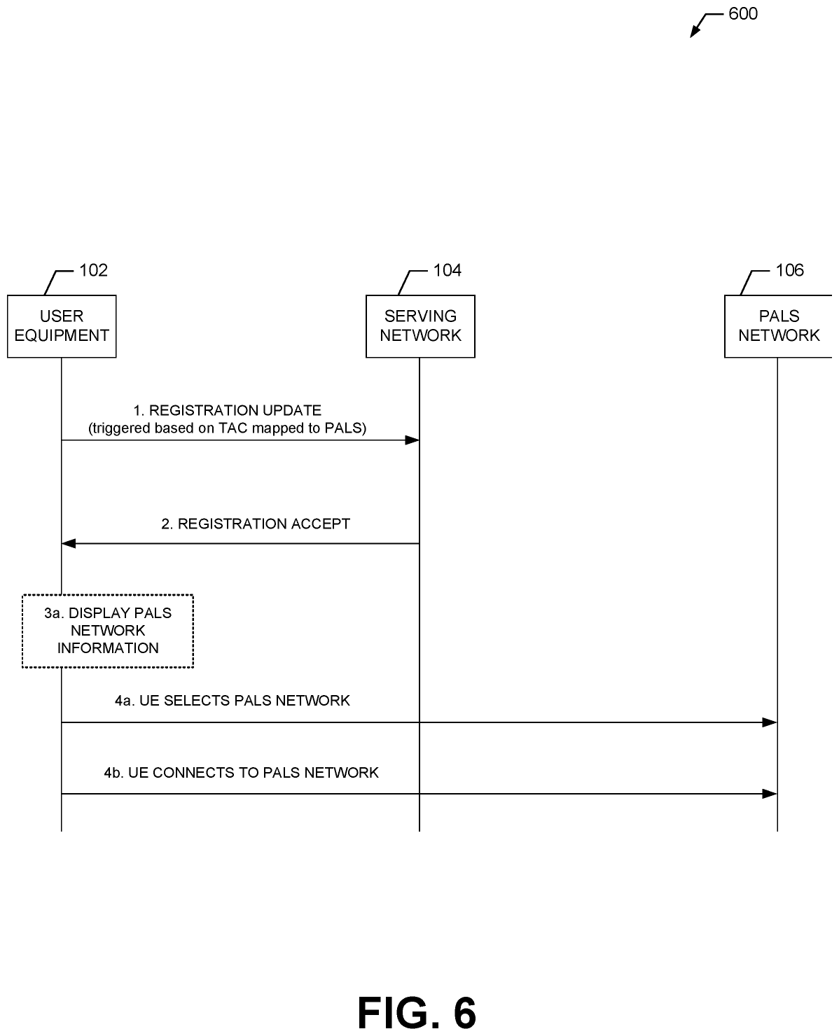

FIG. 6 also illustrates example transmissions between the user equipment 102, the serving network 104 and the PALS network 106 to provide discovery and/or access to localized services associated with the PALS network 106, according to one or more embodiments. In an embodiment, the example transmissions illustrated in FIG. 6 are provided to redirect the user equipment 102 to a portal of the PALS network 106 using a display of PALS network information for manual selection via the user equipment 102.

In an embodiment, the user equipment 102 can send a REGISTRATION UPDATE message to the serving network 104, at 1. In some embodiments, the REGISTRATION UPDATE message can be triggered based on a tracking area code mapped to the PALS network 106. For example, the REGISTRATION UPDATE message can be triggered based on one or more changes to the tracking area and/or the tracking area code. In one or more embodiments, the REGISTRATION UPDATE message is generated in response to a tracking area code received by the user equipment 102 which maps to a PALS network 106 configured to provide localized services. In one or more embodiments, the serving network 104 can detect that the user equipment 102 has moved to a tracking area where PALS service for the PALS network 106 is offered. The serving network 104, or another suitable network entity of the communication system, can perform a registration update process, a UCU process, and/or a SoR process associated with the tracking area change. In one or more embodiments, an AMF of the serving network 104 is configured to provide network information regarding a PALS network (e.g., the PALS network 106) associated with the tracking area.

Additionally, the serving network 104, or another suitable network entity of the communication system, can send a REGISTRATION ACCEPT message to the user equipment 102, at 2. The REGISTRATION ACCEPT message can include network information (e.g., PALS network information) for the PALS network 106. In an embodiment, the network information for the PALS network 106 can be generated in response to a registration update process performed by the user equipment 102 registered in the serving network 104. In another embodiment, the network information for the PALS network 106 can be provided via UCU by the serving network 104. In another embodiment, the network information for the PALS network 106 can be provided via SoR by the serving network 104. The network information (e.g., PALS network information) for the PALS network 106 can be configured to provide information regarding the PALS network 106 to allow the user equipment 102 to obtain connectivity with respect to a PALS network portal of the PALS network 106. For example, the network information (e.g., PALS network information) for the PALS network 106 can be configured to provide information regarding the PALS network 106 to allow the user equipment 102 to obtain access to the PALS network 106. In an embodiment, the network information (e.g., PALS network information) for the PALS network 106 includes a SNPN identifier for the PALS network 106. Additionally or alternatively, the network information (e.g., PALS network information) for the PALS network 106 includes a PLMN identifier for the PALS network 106. Additionally or alternatively, the network information (e.g., PALS network information) for the PALS network 106 includes a DNN for the PALS network 106. Additionally or alternatively, the network information (e.g., PALS network information) for the PALS network 106 includes a S-NSSAI for the PALS network 106. Additionally the network information (e.g., PALS network information) for the PALS network 106 includes an N3IWF IP address, and/or one or more credential to obtain PALS network connectivity via Nwu.

At 3a, PALS network information is displayed. For example, in one or more embodiments, PALS network information is displayed via a display of the user equipment 102 to facilitate selecting the PALS network 106 for a connection between the user equipment 102 and the PALS network 106. In one or more embodiments where onboarding functionality is leveraged, a GIN mapping to the PALS network 106 is displayed.

At 4a, the user equipment 102 selects the PALS network 106. For example, in certain embodiments, the user equipment 102 can choose whether to connect to the PALS network 106 directly or via NWu connectivity from the serving network 104 to the PALS network 106. In an embodiment, the user equipment 102 can send a PDU SESSION message from the serving network 104 or in the PALS network 106. In an embodiment, the user equipment 102 can send a PDU SESSION message from the serving network 104 to the PALS network 106 via an NWu interface. In certain embodiments, the serving network 104 can redirect the traffic to a PALS network portal of the PALS network 106 using one or more policies, one or more policy detection rules, and/or one or more forward action rules for the serving network 104 and/or the PALS network 106. In another embodiment, the user equipment 102 is registered in the PALS network 106 and can send the PDU SESSION message directly within the PALS network 106. In one or more embodiments, the user equipment 102 initiates a PDU session and/or a PDU session update (e.g., a PDU session and/or a PDU session update with respect to the PALS network 106) via the PDU SESSION message. In one or more embodiments, the user equipment 102 can employ an internet PDU session, reactivate a PDU session, and/or employ a link provided by the serving network 104 (e.g., a link included in one or more protocol configuration options) to transmit traffic via the PDU session to the PALS network 106. In one or more embodiments, the user equipment 102 generates the PDU SESSION message (e.g., initiates the PDU session and/or a PDU session update) using the network information (e.g., PALS network information) for the PALS network 106. For example, in one or more embodiments, the user equipment 102 generates the PDU SESSION message (e.g., initiates the PDU session and/or a PDU session update) using the DNN, the S-NSSAI, the SNPN ID, the PLMN ID, and/or other network information associated with the PALS network 106.

Additionally or alternatively, the user equipment 102 can connect to the PALS network 106, at 4b. For example, the user equipment 102 can establish a connection between the user equipment 102 and the PALS network 106 in response to the PDU SESSION message. In one or more embodiments, the user equipment 102 can connect to the PALS network 106 based on connectivity information, one or more subscriptions, and/or one or more authorizations obtained for, and/or provided by, the PALS network 106. In an embodiment, the user equipment 102 can connect to the PALS network 106 via a direct connection between the user equipment 102 and the PALS network 106. In another embodiments, the user equipment 102 can connect to the PALS network 106 via a NWu reference point between the user equipment 102 and a N3IWF of the PALS network 106 (e.g., via NWu connectivity). In certain embodiments, the user equipment 102 can connect to the PALS network 106 based on a N3IWF address of the PALS network 106.

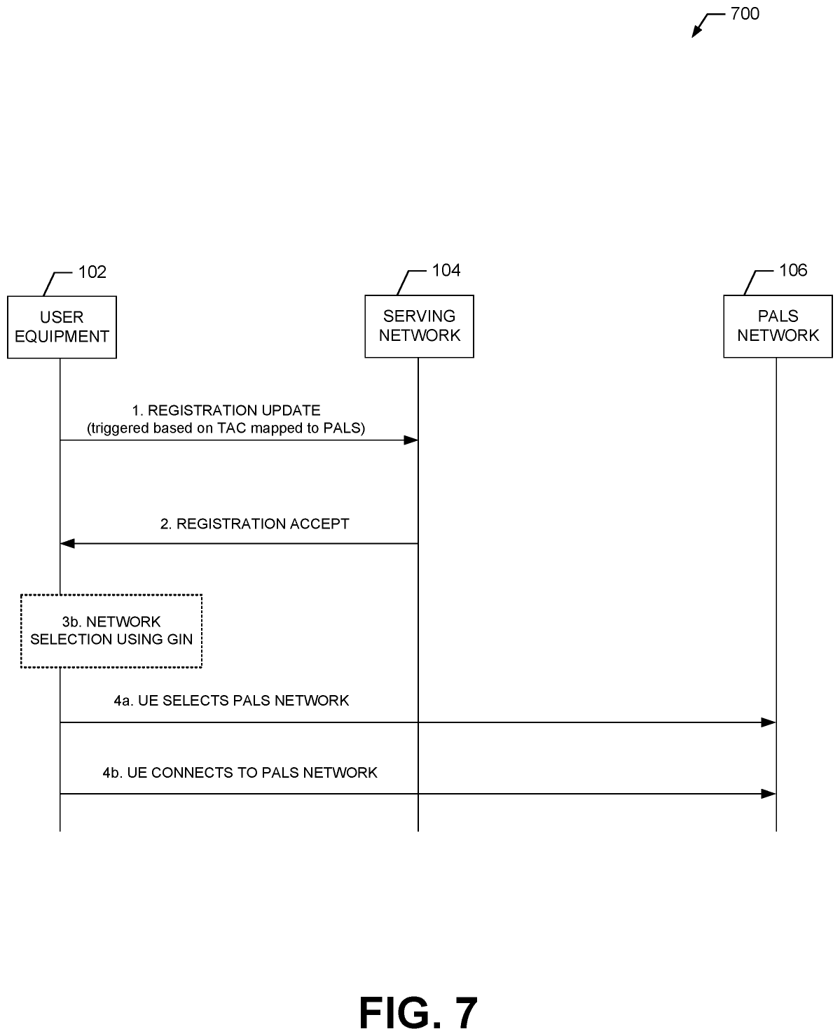

FIG. 7 also illustrates example transmissions between the user equipment 102, the serving network 104 and the PALS network 106 to provide discovery and/or access to localized services associated with the PALS network 106, according to one or more embodiments. In an embodiment, the example transmissions illustrated in FIG. 7 are provided to allow the user equipment 102 to select a PALS network based on a group identifier for network selection (GIN) provided by the serving network and connect to the respective PALS network.

In an embodiment, the user equipment 102 can send a REGISTRATION UPDATE message to the serving network 104, at 1. In some embodiments, the REGISTRATION UPDATE message can be triggered based on a change of the tracking area where the new tracking area code is associated with the PALS network 106 configured to provide localized services. In one or more embodiments, the serving network 104 can detect that the user equipment 102 has moved to a tracking area where PALS service 106 is offered by the PALS network 106. The serving network 104, or another suitable network entity of the communication system, can perform a registration update process, a UCU process, and/or a SoR process associated with the REGISTRATION UPDATE message. In one or more embodiments, an AMF of the serving network 104 is configured to provide network information regarding a PALS network (e.g., the PALS network 106) associated with the tracking area.

Additionally, the serving network 104, or another suitable network entity of the communication system, can send a REGISTRATION ACCEPT message to the user equipment 102, at 2. The REGISTRATION ACCEPT message can include network information (e.g., PALS network information) for the PALS network 106. In an embodiment, the network information for the PALS network 106 can be generated in response to a registration update process performed by the serving network 104. In another embodiment, the network information for the PALS network 106 can be generated using a UCU process performed by the serving network 104. In another embodiment, the network information for the PALS network 106 can be generated using a SoR process performed by the serving network 104. The network information (e.g., PALS network information) for the PALS network 106 can be configured to provide information regarding the PALS network 106 to allow the user equipment 102 to obtain connectivity with respect to a PALS network portal of the PALS network 106. For example, the network information (e.g., PALS network information) for the PALS network 106 can be configured to provide information regarding the PALS network 106 to allow the user equipment 102 to obtain access to the PALS network 106. In an embodiment, the network information (e.g., PALS network information) for the PALS network 106 includes a GIN provided to the user equipment 102. Additionally or alternatively, the network information (e.g., PALS network information) for the PALS network 106 includes a SNPN identifier for the PALS network 106. Additionally or alternatively, the network information (e.g., PALS network information) for the PALS network 106 includes a PLMN identifier for the PALS network 106. Additionally or alternatively, the network information (e.g., PALS network information) for the PALS network 106 includes a DNN used by the PALS network 106. Additionally or alternatively, the network information (e.g., PALS network information) for the PALS network 106 includes a S-NSSAI used by the PALS network 106. Additionally or alternatively, the network information (e.g., PALS network information) for the PALS network 106 includes a link to a network portal (e.g., a PALS network portal) used by the PALS network 106.

At 3b, network selection using GIN is provided. For example, in one or more embodiments, network selection using GIN is provided via the user equipment 102 to facilitate selecting the PALS network 106 for a connection between the user equipment 102 and the PALS network 106. In one or more embodiments, the serving network 104 triggers the user equipment 102 to perform scanning using UCU. Additionally, in one or more embodiments, the serving network 104 broadcasts GIN (e.g., along with display of a human readable network name via a human machine interface of the user equipment 102). In one or more embodiments where onboarding functionality is leveraged, the GIN is mapped to the PALS network 106. In certain embodiments, the serving network 104 additionally broadcasts an indicator that the GIN can be employed for PALS network selection with respect to the PALS network 106. In one or more embodiments, the user equipment 102 displays the human readable network name via the human machine interface or the GIN (or the indicator broadcasted by the serving network 104) to facilitate selecting the PALS network 106 for a connection between the user equipment 102 and the PALS network 106.

At 4a, the user equipment 102 selects the PALS network 106. For example, in certain embodiments, the user equipment 102 can choose whether to connect to the PALS network 106 directly or via NWu connectivity from the serving network 104 to the PALS network 106. In certain embodiments, if network selection is provided using the GIN, a network selection algorithm of the user equipment 102 can employ the GIN to select the PALS network 106. In an embodiment, the user equipment 102 can send a PDU SESSION message from the serving network 104 via NWu connectivity to the PALS network 106 or directly to the PALS network 106. In certain embodiments, the serving network 104 can redirect traffic from the user equipment 102 to a PALS network portal of the PALS network 106 using one or more policies, one or more policy detection rules, and/or one or more forward action rules for the serving network 104 and/or the PALS network 106. In one or more embodiments, the user equipment 102 initiates a PDU session and/or a PDU session update (e.g., a PDU session and/or a PDU session update with respect to the PALS network 106) via the PDU SESSION message. In one or more embodiments, the user equipment 102 can employ an internet PDU session, reactivate a PDU session, and/or employ a link provided by the serving network 104 (e.g., a link included in one or more protocol configuration options) to transmit traffic via the PDU session to the PALS network 106. In one or more embodiments, the user equipment 102 generates the PDU SESSION message (e.g., initiates the PDU session and/or a PDU session update) using the network information (e.g., PALS network information) for the PALS network 106. For example, in one or more embodiments, the user equipment 102 generates the PDU SESSION message (e.g., initiates the PDU session and/or a PDU session update) using the DNN, the S-NSSAI, the SNPN ID, the PLMN ID, and/or other network information associated with the PALS network 106.

Additionally, the user equipment 102 can connect to the PALS network 106, at 4b. For example, the user equipment 102 can establish a connection between the user equipment 102 and the PALS network 106 in response to the PDU SESSION message. In one or more embodiments, the user equipment 102 can connect to the PALS network 106 based on connectivity information, one or more subscriptions, and/or one or more authorizations obtained for, and/or provided by, the PALS network 106. In an embodiment, the user equipment 102 can connect to the PALS network 106 via a direct connection between the user equipment 102 and the PALS network 106. In another embodiment, the user equipment 102 can connect to the PALS network 106 via a NWu reference point between the user equipment 102 and a N3IWF of the PALS network 106 (e.g., via NWu connectivity). In certain embodiments, the user equipment 102 can connect to the PALS network 106 based on a N3IWF address of the PALS network 106.

In one or more embodiments, the GIN is mapped to the PALS network 106 and broadcasted by serving network 104 (or via another broadcast indicator) to indicate one or more services available to the user equipment 102 and/or provided by the PALS network 106. For example, when the user equipment is employing the serving network 104 (e.g., HPLMN or VPLMN), the serving network 104 can detect the location (e.g., tracking area, Cell ID, global positioning system coordinates, etc.) of the user equipment. The serving network 104 can also provide information regarding available PALS networks using GIN. In certain embodiments, the serving network 104 can broadcast the GIN along with an indicator that the GIN can be employed for network selection with respect to the PALS network 106. In certain embodiments, the GIN, the other identifier, and/or other information (e.g., a human readable network name) may also be displayed via the user equipment 102 to provide for manual selection of a PALS network (e.g., the PALS network 106).

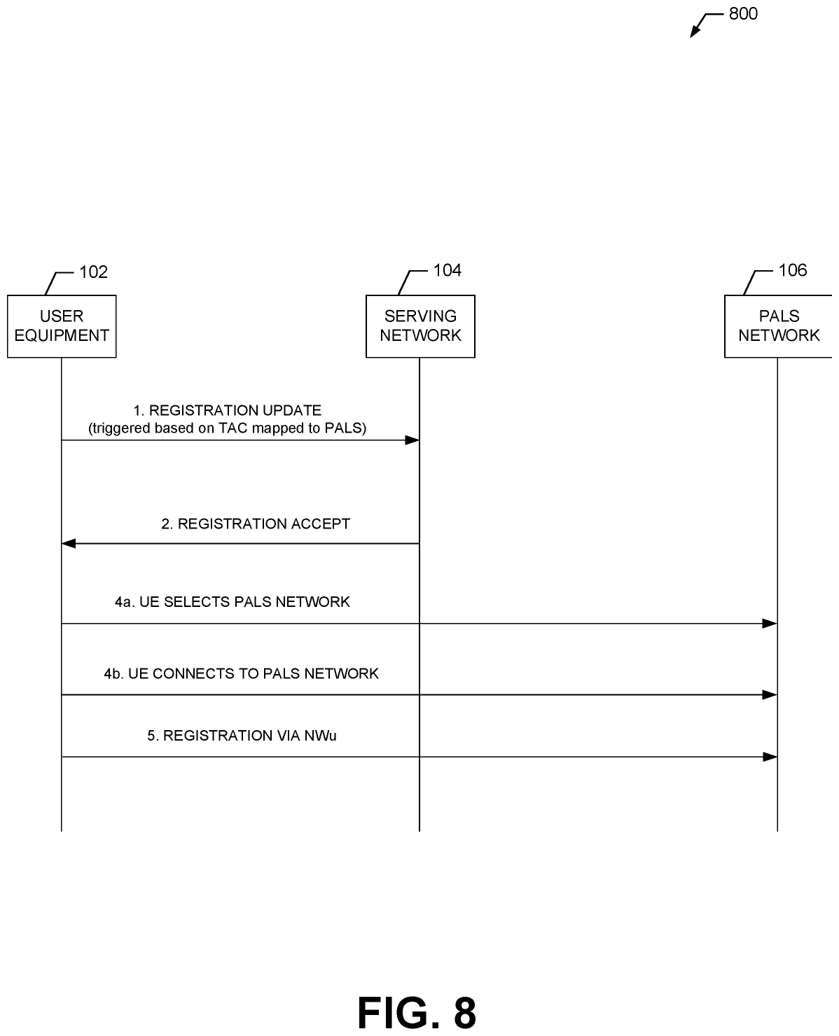

FIG. 8 also illustrates example transmissions between the user equipment 102, the serving network 104 and the PALS network 106 to provide discovery and/or access to localized services associated with the PALS network 106, according to one or more embodiments. In an embodiment, the example transmissions illustrated in FIG. 8 are provided for onboarding and/or registration in the PALS network 106 via an underlay network (e.g., using NWu).

In an embodiment, the user equipment 102 can send a REGISTRATION UPDATE message to the serving network 104, at 1. In some embodiments, the REGISTRATION UPDATE message can be triggered based on a change of the tracking area where the new tracking area code is associated with the PALS network 106 configured to provide localized services. In one or more embodiments, the serving network 104 can detect that the user equipment 102 has moved to a tracking area where PALS service for the PALS network 106 is offered. The serving network 104, or another suitable network entity of the communication system, can perform a registration update process, a UCU process, and/or a SoR process associated with the REGISTRATION UPDATE message. In one or more embodiments, an AMF of the serving network 104 is configured to provide network information regarding a PALS network (e.g., the PALS network 106) associated with the tracking area.

Additionally, the serving network 104, or another suitable network entity of the communication system, can send a REGISTRATION ACCEPT message to the user equipment 102, at 2. The REGISTRATION ACCEPT message can include network information (e.g., PALS network information) for the PALS network 106. In an embodiment, the network information for the PALS network 106 can be generated in response to a registration update request message performed by the user equipment 102. In another embodiment, the network information for the PALS network 106 can be provided via UCU process triggered by the serving network 104. In another embodiment, the network information for the PALS network 106 can be provided via an SoR process triggered by the serving network 104. The network information (e.g., PALS network information) for the PALS network 106 can be configured to provide information regarding the PALS network 106 to allow the user equipment 102 to obtain connectivity with respect to a PALS network portal of the PALS network 106. For example, the network information (e.g., PALS network information) for the PALS network 106 can be configured to provide information regarding the PALS network 106 to allow the user equipment 102 to obtain access to the PALS network 106. In an embodiment, the network information (e.g., PALS network information) for the PALS network 106 includes a SNPN identifier for the PALS network 106. Additionally or alternatively, the network information (e.g., PALS network information) for the PALS network 106 includes a PLMN identifier for the PALS network 106. Additionally, the network information (e.g., PALS network information) for the PALS network 106 includes a DNN for the PALS network 106. Additionally or alternatively, the network information (e.g., PALS network information) for the PALS network 106 includes a S-NSSAI for the PALS network 106. Additionally, the network information (e.g., PALS network information) for the PALS network 106 includes a link to a network portal (e.g., a PALS network portal) for the PALS network 106. In certain embodiments, network selection is provided via the display of the PALS network information on the display of the user equipment 102. In certain embodiments, network selection is provided using GIN or other broadcast indications.

At 4a, the user equipment 102 selects the PALS network 106. For example, in certain embodiments, the user equipment 102 can choose whether to connect to the PALS network 106 directly or via NWu connectivity from the serving network 104. In certain embodiments, if network selection is provided using the GIN or other broadcast indications, a network selection algorithm of the user equipment 102 can employ the GIN or other broadcast indications to select the PALS network 106. In an embodiment, the user equipment 102 can send a PDU SESSION message to the serving network 104 and/or the PALS network 106. In an embodiment, the user equipment 102 can send a PDU SESSION message via NWu connectivity from the serving network 104 to the PALS network 106. In certain embodiments, the serving network 104 can redirect traffic from the user equipment 102 to a PALS network portal of the PALS network 106 using one or more policies, one or more policy detection rules, and/or one or more forward action rules for the serving network 104 and/or the PALS network 106. In another embodiment, the user equipment 102 can send the PDU SESSION message directly to the PALS network 106. In one or more embodiments, the user equipment 102 initiates a PDU session and/or a PDU session update (e.g., a PDU session and/or a PDU session update with respect to the PALS network 106) via the PDU SESSION message. In one or more embodiments, the user equipment 102 can employ an internet PDU session, reactivate a PDU session, and/or employ a link provided by the serving network 104 (e.g., a link included in one or more protocol configuration options) to transmit traffic to the PALS network 106. In one or more embodiments, the user equipment 102 generates the PDU SESSION message (e.g., initiates the PDU session and/or a PDU session update) using the network information (e.g., PALS network information) for the PALS network 106. For example, in one or more embodiments, the user equipment 102 generates the PDU SESSION message (e.g., initiates the PDU session and/or a PDU session update) using the DNN, the S-NSSAI, the SNPN ID, the PLMN ID, and/or other network information associated with the PALS network 106.

Additionally, the user equipment 102 can connect to the PALS network 106, at 4b. For example, the user equipment 102 can establish a connection between the user equipment 102 and the PALS network 106 in response to the PDU SESSION message. In one or more embodiments, the user equipment 102 can connect to the PALS network 106 based on connectivity information, one or more subscriptions, and/or one or more authorizations obtained for, and/or provided by, the PALS network 106. In an embodiment, the user equipment 102 can connect to the PALS network 106 via a direct connection between the user equipment 102 and the PALS network 106. In another embodiment, the user equipment 102 can connect to the PALS network 106 via a NWu reference point between the user equipment 102 and a N3IWF of the PALS network 106 (e.g., via NWu connectivity). In certain embodiments, the user equipment 102 can connect to the PALS network 106 based on a N3IWF address of the PALS network 106.

In addition, registration via NWu is provided, at 5. For example, registration of the user equipment 102 with respect to the PALS network 106 can be provided via NWu. In one or more embodiments, registration of the user equipment 102 with respect to the PALS network 106 using an onboarding feature via NWu connectivity. For example, in an embodiment, the user equipment 102 can be registered with respect to the PALS network 106 based on an onboarding feature via a NWu reference point between the user equipment and a N3IWF of the PALS network 106. In certain embodiments, a registration procedure for an AMF of the PALS network 106 associated with N3IWF can support the onboarding feature using an onboarding subscription concealed identifier (SUCI).

In one or more embodiments, the user equipment 102 can access the PALS network 106 without credentials or with default credentials (e.g., triggered by the GIN broadcasted by the serving network 104). However, in certain embodiments, a PDU session from the user equipment 102 can be restricted to access only a PALS portal page where the user equipment 102 can be provisioned with service data and/or network related data associated with the PALS network 106. In certain embodiments, onboarding to the PALS network 106 can include an onboarding SUCI/SUPI which can be configured on the user equipment 102 by the serving network 104 together with other data (e.g., default credentials to establish connectivity via NWu) via UCU once the user equipment 102 is determined to be in vicinity of the PALS network 106. In certain embodiments, a registration procedure performed using NWu can employ onboarding SUCI such that the PALS network 106 is configured as an overlay network and the serving network 104 is configured as an underlay network.

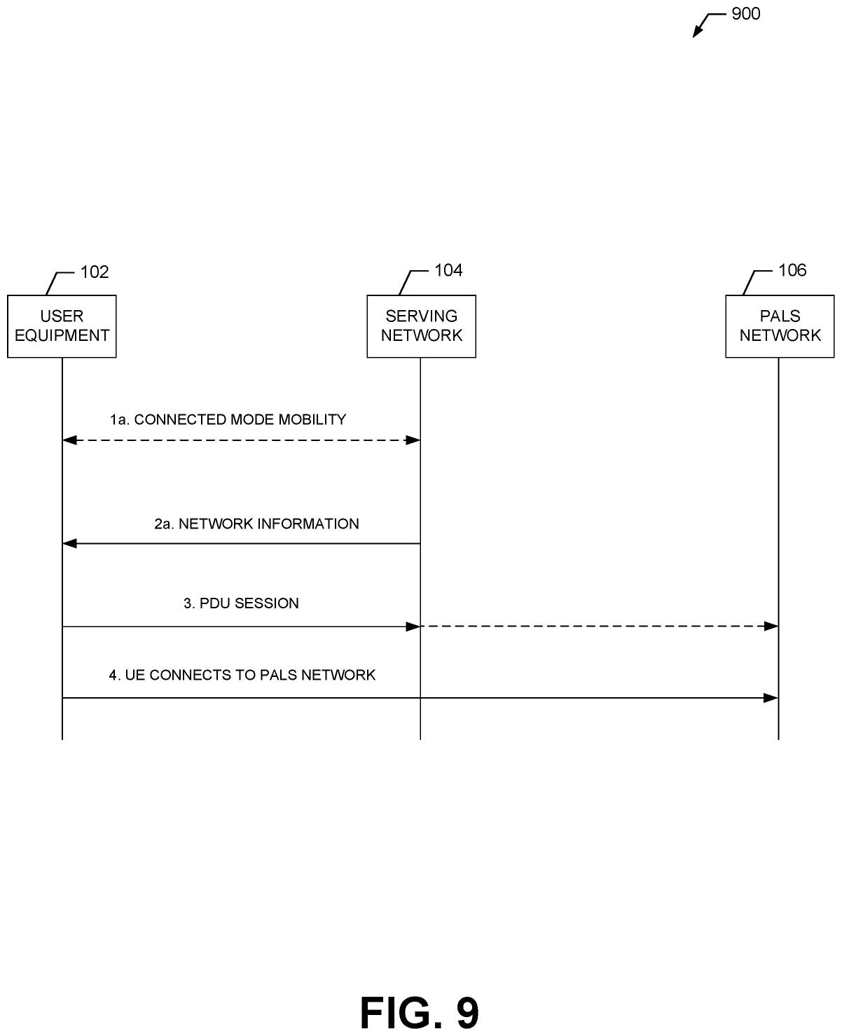

FIG. 9 also illustrates example transmissions between the user equipment 102, the serving network 104 and the PALS network 106 to provide discovery and/or access to localized services associated with the PALS network 106, according to one or more embodiments. In an embodiment, the example transmissions illustrated in FIG. 9 are provided for handling connected mode mobility.

In an embodiment, connected mode mobility is performed between the user equipment 102 and the serving network 104, at 1a. In one or more embodiments, upon completion of a hand over process associated with the user equipment 102 and/or the serving network 104, the serving network 104 can detect that the user equipment 102 has moved to a tracking area where PALS service for the PALS network 106 is offered. For example, in one or more embodiments, the user equipment 102 can be in a radio resource control (RRC) connected state with respect to the serving network 104. Furthermore, the user equipment 102 can be associated with a handover to a tracking area or the user equipment 102 can transition from an RRC inactive state to an RCC active state in a tracking area where the PALS network 106 is available. The serving network 104, or another suitable network entity of the communication system, can perform a UCU process, and/or a SoR process to provide the user equipment 102 with network information associated with the PALS Network 106 when the serving network 104 detects that the user equipment 102 has moved to a tracking area where the PALS Network 106 is available. In one or more embodiments, an AMF of the serving network 104 provides network information regarding a PALS network (e.g., the PALS network 106).

Additionally, the serving network 104, or another suitable network entity of the communication system, can send network information to the user equipment 102, at 2a. The network information can be, for example, PALS network information for the PALS network 106. In an embodiment, the network information for the PALS network 106 can be generated in response to a registration update process performed by the serving network 104. In another embodiment, the network information for the PALS network 106 can be provided as part of UCU process performed by the serving network 104. In another embodiment, the network information for the PALS network 106 can be generated in response to a SoR process performed by the serving network 104. The network information (e.g., PALS network information) for the PALS network 106 can be configured to provide information regarding the PALS network 106 to allow the user equipment 102 to obtain connectivity with respect to a PALS network portal of the PALS network 106. For example, the network information (e.g., PALS network information) for the PALS network 106 can be configured to provide information regarding the PALS network 106 to allow the user equipment 102 to obtain access to the PALS network 106. In an embodiment, the network information (e.g., PALS network information) for the PALS network 106 includes a SNPN identifier for the PALS network 106. Additionally or alternatively, the network information (e.g., PALS network information) for the PALS network 106 includes a PLMN identifier for the PALS network 106. Additionally, the network information (e.g., PALS network information) for the PALS network 106 includes a DNN for the PALS network 106. Additionally, the network information (e.g., PALS network information) for the PALS network 106 includes a S-NSSAI for the PALS network 106. Additionally, the network information (e.g., PALS network information) for the PALS network 106 includes a link to a network portal (e.g., a PALS network portal) for the PALS network 106.

At 3, the user equipment 102 can send a PDU SESSION message to the serving network 104 to access the PALS network 106. In an embodiment, the user equipment 102 can send the PDU SESSION message to the serving network 104 and the serving network 104 can forward the PDU SESSION message to the PALS network 106. In certain embodiments, the serving network 104 can redirect traffic from the user equipment 102 to a PALS network portal of the PALS network 106 using one or more policies, one or more policy detection rules, and/or one or more forward action rules in the serving network 104 and/or in the PALS network 106. In one or more embodiments, the user equipment 102 initiates a PDU session and/or a PDU session update (e.g., a PDU session and/or a PDU session update with respect to the PALS network 106) via the PDU SESSION message. The PDU session can be configured to transmit IP traffic data. In certain embodiments, the user equipment 102 can be configured to access the PALS network portal of the PALS network 106 to facilitate the PDU session. In certain embodiments, the user equipment 102 can be redirected to the PALS network portal of the PALS network 106 to facilitate the PDU session. In one or more embodiments, the user equipment 102 can employ an internet PDU session, reactivate a PDU session, and/or employ a link provided by the serving network 104 (e.g., a link included in one or more protocol configuration options) to transmit traffic via the PDU session to the PALS network 106. In one or more embodiments, the user equipment 102 generates the PDU SESSION message (e.g., initiates the PDU session and/or a PDU session update) using the network information (e.g., PALS network information) for the PALS network 106. For example, in one or more embodiments, the user equipment 102 generates the PDU SESSION message (e.g., initiates the PDU session and/or a PDU session update with the serving network 104) using the DNN, the S-NSSAI, the SNPN ID, the PLMN ID, and/or other network information associated with the PALS network 106. Furthermore, the serving network 104 redirects a UE session associated with the user equipment 102 to the PALS network 106 (e.g., to the PALS network portal of the PALS network 106). In another embodiment, the user equipment 102 can send the PDU SESSION message directly to the PALS network 106. For example, in some embodiments, the user equipment 102 can establish a PDU session with the serving network 104 and can further access a URL of the PALS network 106.

Additionally, the user equipment 102 can connect to the PALS network 106, at 4. For example, the user equipment 102 can establish a connection between the user equipment 102 and the PALS network. In one or more embodiments, the user equipment 102 can connect to the PALS network 106 based on connectivity information, one or more subscriptions, and/or one or more authorizations obtained for, and/or provided by, the PALS network 106. In an embodiment, the user equipment 102 can connect to the PALS network 106 via a direct connection between the user equipment 102 and the PALS network 106. In another embodiment, the user equipment 102 can connect to the PALS network 106 via a NWu reference point between the user equipment 102 and a N3IWF of the PALS network 106 (e.g., via NWu connectivity). In certain embodiments, the user equipment 102 can connect to the PALS network 106 based on a N3IWF address of the PALS network 106.

In one or more embodiments, the user equipment 102 is redirected to a PALS network portal of the PALS network 106. For example, when the user equipment is employing the serving network 104 (e.g., HPLMN or VPLMN), the serving network 104 can detect the location (e.g., tracking area, Cell ID, global positioning system coordinates, etc.) of the user equipment. Furthermore, in response to a determination that the user equipment 102 is in a vicinity of the PALS network 106, the serving network 104 can provide the network information (e.g., a URL or other data) to connect to a PALS portal page of the PALS network 106. In an embodiment, the network information can be provided to the user equipment using one or more protocol configuration options, UCU and/or SoR. In certain embodiments, based on one or more user preference for a user identifier associated with the user equipment 102, the user equipment can subscribe to the PALS network 106 via the PALS portal (e.g., identified by URL, etc.) and can connect to the PALS network 106.

In one or more embodiments, a UCU can be employed to provide the network information for the PALS network 106. For example, when the user equipment is employing the serving network 104 (e.g., HPLMN or VPLMN), the serving network 104 can detect the location (e.g., tracking area, Cell ID, global positioning system coordinates, etc.) of the user equipment. The serving network 104 can also provide information regarding available PALS networks (e.g., PLMN ID, SNPN ID, etc.) in a given area associated with the user equipment 102 using UCU process. In certain embodiments, the serving network 104 can provide the information regarding the PALS network 106 directly to the user equipment when the user equipment 102 enters an area associated with the PALS network 106. Alternatively, in certain embodiments, the serving network 14 can establish one or more agreements with the PALS network 106 to provide the network information to the UE via SoR. In one or more embodiments, the user equipment 102 can select and/or access the PALS network 106 directly using the received information. Alternatively, the user equipment 102 can connect from the serving network 104 to PALS network 106 via NWu interface to a N3IWF located in the PALS network 106. An N3IWF address of the N3IWF located in the PALS network 106 and/or one or more credentials to access the PALS network 106 can also be configured via UCU or SoR on the user equipment 102. The one or more credentials can be specific to the user equipment 102 and/or can be usable by one or more other user equipment (e.g., one or more other user equipment serviced by the serving network 104).

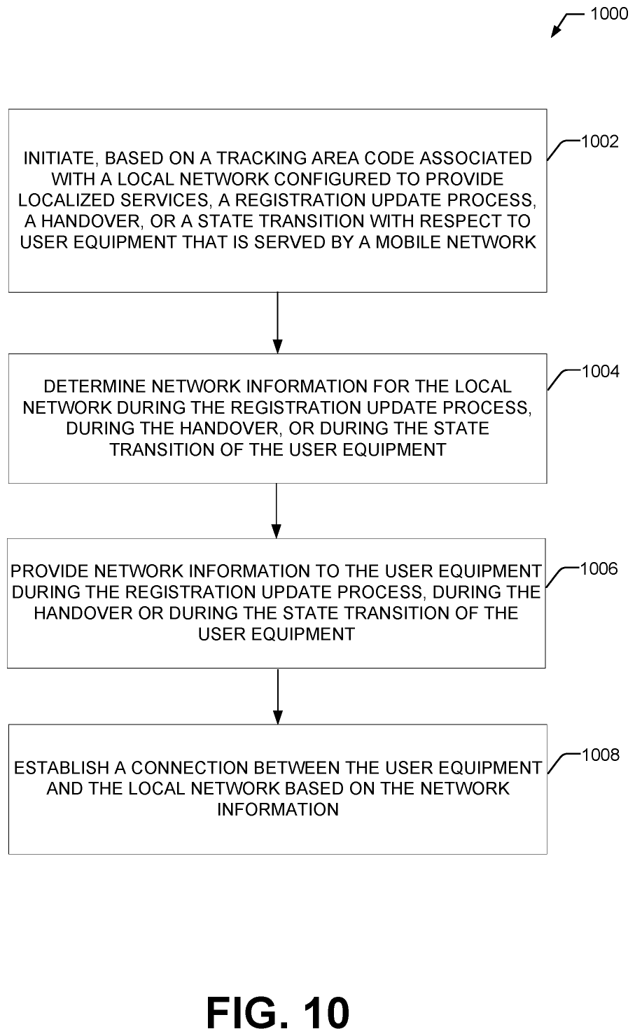

FIG. 10 illustrates a flowchart depicting a method 1000 according to an example embodiment of the present disclosure. It will be understood that each block of the flowchart and combination of blocks in the flowchart can be implemented by various means, such as hardware, firmware, processor, circuitry, and/or other communication devices associated with execution of software including one or more computer program instructions. For example, one or more of the procedures described above can be embodied by computer program instructions. In this regard, the computer program instructions which embody the procedures described above can be stored, for example, by the memory 404 of the apparatus 400 employing an embodiment of the present disclosure and executed by the processing circuitry 402. As will be appreciated, any such computer program instructions can be loaded onto a computer or other programmable apparatus (for example, hardware) to produce a machine, such that the resulting computer or other programmable apparatus implements the functions specified in the flowchart blocks. These computer program instructions can also be stored in a computer-readable memory that can direct a computer or other programmable apparatus to function in a particular manner, such that the instructions stored in the computer-readable memory produce an article of manufacture the execution of which implements the function specified in the flowchart blocks. The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Referring now to FIG. 10, the operations performed, such as by the apparatus 400 of FIG. 4, in order to provide for discovery and/or access to localized services provided by a communication network are depicted, in accordance with one or more embodiments of the present disclosure. As shown in block 1002 of FIG. 10, based on a tracking area code associated with a local network configured to provide localized services, the apparatus 400 includes means, such as the processing circuitry 402, the memory 404, or the like, configured to initiate a registration update process, a handover, or a state transition with respect to user equipment that is served by a mobile network. In certain embodiments, the initiating the registration update process comprises determining the local network via an AMF of the local network.

As shown in block 1004 of FIG. 10, the apparatus 400 includes means, such as the processing circuitry 402, the memory 404, or the like, configured to determine network information for the local network during the registration update process, during the handover, or during the state transition of the user equipment. In certain embodiments, the determining the network information comprises determining a GIN for the local network (e.g., a GIN mapped to the local network). In certain embodiments, the determining the network information comprises determining a SNPN identifier for the local network. In certain embodiments, the determining the network information comprises determining a PLMN identifier for the local network. In certain embodiments, the determining the network information comprises determining a DNN for the local network. In certain embodiments, the determining the network information comprises determining a S-NSSAI for the local network. In certain embodiments, the determining the network information comprises determining an N3IWF of the local network. In certain embodiments, the determining the network information comprises determining a link to a network portal for the local network.

As shown in block 1006 of FIG. 10, the apparatus 400 includes means, such as the processing circuitry 402, the memory 404, or the like, configured to provide network information to the user equipment during the registration update process, during the handover or during the state transition of the user equipment.

As shown in block 1008 of FIG. 10, the apparatus 400 includes means, such as the processing circuitry 402, the memory 404, or the like, configured to establish a connection between the user equipment and the local network based on the network information. For example, in certain embodiments, the establishing the connection comprises establishing the connection based on the GIN, the SNPN identifier, the PLMN identifier, the DNN, the S-NSSAI, the N3IWF, the link to the network portal, and/or other network information for the local network. In certain embodiments, the establishing the connection comprises establishing, based on the network information, a direct connection between the user equipment and the local network. In certain embodiments, the establishing the connection comprises establishing, based on the network information, the connection between the user equipment and the local network via a NWu reference point between the user equipment and a N3IWF of the local network. In certain embodiments, the establishing the connection comprises establishing the connection between the user equipment and the local network in addition to another connection between the user equipment and a mobile network. In an embodiment, the mobile network is a serving network for the user equipment.

In certain embodiments, the apparatus 400, such as the processing circuitry 402, can additionally or alternatively be configured to initiate a PDU session with respect to the local network based on the network information. In certain embodiments, the apparatus 400, such as the processing circuitry 402, can additionally or alternatively be configured to display the network information via a display of the user equipment. Furthermore, in certain embodiments, the apparatus 400, such as the processing circuitry 402, can additionally or alternatively be configured to select the local network for the connection between the user equipment and the local network based on the displaying of the network information via the display of the user equipment. In certain embodiments, the apparatus 400, such as the processing circuitry 402, can additionally or alternatively be configured to select the local network for the connection between the user equipment and the local network based on information broadcasted by the mobile network. In certain embodiments, the apparatus 400, such as the processing circuitry 402, can additionally or alternatively be configured to select the local network for the connection between the user equipment and the local network based on a GIN that is mapped to the local network. In certain embodiments, the apparatus 400, such as the processing circuitry 402, can additionally or alternatively be configured to select the local network for the connection between the user equipment and the local network based on the GIN and an additional indicator broadcasted by the mobile network serving the user equipment. In certain embodiments, the apparatus 400, such as the processing circuitry 402, can additionally or alternatively be configured to perform registration of the user equipment in the local network based on an onboarding feature via a NWu reference point between the user equipment and a N3IWF of the local network.

As described above, FIG. 10 is a flowchart of various methods that can be carried out by, e.g., the apparatus 400, and/or according to a computer program product, according to example embodiments of the disclosure. A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as, e.g., in conjunction with the communications flowcharts of FIGS. 5-9 or as part of the system of FIG. 1. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method, comprising:
initiating, based on a tracking area code associated with a local network configured to provide localized services, a registration update process, a handover, or a state transition with respect to user equipment that is served by a mobile network;
determining network information for the local network during the registration update process, during the handover, or during the state transition of the user equipment;
receiving network information at the user equipment during the registration update process, during the handover, or during the state transition of the user equipment; and
establishing a connection between the user equipment and the local network based on the network information.

2. The method of claim 1, wherein the determining the network information comprises determining a group identifier for network selection (GIN) for the local network.

3. The method of claim 1, wherein the determining the network information comprises determining a Standalone Non-Public Network (SNPN) identifier for the local network.

4. The method of claim 1, wherein the determining the network information comprises determining a Public Land Mobile Network (PLMN) identifier for the local network.

5. The method of claim 1, wherein the determining the network information comprises determining a single network slice selection assistance information (S-NSSAI) for the local network.

6. The method of claim 1, wherein the determining the network information comprises determining a Non-3GPP Interworking Function (N3IWF) for the local network.

7. The method of claim 1, wherein the determining the network information comprises determining a link to a network portal for the local network.

8. The method of claim 1, wherein the establishing the connection comprises establishing, based on the network information, a direct connection between the user equipment and the local network.

9. The method of claim 1, wherein the establishing the connection comprises establishing, based on the network information, the connection between the user equipment and the local network via a NWu reference point between the user equipment and a Non-3GPP Interworking Function (N3IWF) of the local network.

10. The method of claim 1, wherein the establishing the connection comprises establishing the connection between the user equipment and the local network in addition to another connection between the user equipment and a mobile network.

11. The method of claim 1, further comprising:
initiating a packet data unit (PDU) session within the local network based on the network information.

12. The method of claim 1, further comprising:
displaying the network information via a display of the user equipment; and
based on the displaying of the network information via the display of the user equipment, selecting the local network for the connection between the user equipment and the local network.

13. The method of claim 1, further comprising:
selecting the local network for the connection between the user equipment and the local network based on information broadcasted by the mobile network.

14. The method of claim 1, further comprising:
selecting the local network for the connection between the user equipment and the local network based on a group identifier for network selection (GIN) that is mapped to the local network.

15. The method of claim 14, further comprising:
selecting the local network for the connection between the user equipment and the local network based on the GIN and an additional indicator broadcasted by the mobile network serving the user equipment.

16. The method of claim 1, further comprising:
performing registration of the user equipment in the local network based on an onboarding feature via a NWu reference point between the user equipment and a Non-3GPP Interworking Function (N3IWF) of the local network.

17. An apparatus comprising processing circuitry and at least one memory including computer program code instructions, the computer program code instructions configured to, when executed by the processing circuitry, cause the apparatus to:
initiate, based on a tracking area code associated with a local network configured to provide localized services, a registration update process, a handover, or a state transition with respect to user equipment that is served by a mobile network;
determine network information for the local network during the registration update process, during the handover, or during the state transition of the user equipment;
receive network information at the user equipment during the registration update process, during the handover, or during the state transition of the user equipment; and
establish a connection between the user equipment and the local network based on the network information.

18. The apparatus of claim 17, wherein the computer program code instructions are further configured to, when executed by the processing circuitry, cause the apparatus to determine a group identifier for network selection (GIN) for the local network based on the registration update process.

19. The apparatus of claim 17, wherein the computer program code instructions are further configured to, when executed by the processing circuitry, cause the apparatus to determine a Standalone Non-Public Network (SNPN) identifier for the local network based on the registration update process.

20-32. (canceled)

33. A computer program product comprising at least one non-transitory computer-readable storage medium having computer-executable program code instructions stored therein, the computer-executable program code instructions comprising program code instructions to:
initiate, based on a tracking area code associated with a local network configured to provide localized services, a registration update process, a handover, or a state transition with respect to user equipment that is served by a mobile network;
determine network information for the local network during the registration update process, during the handover, or during the state transition of the user equipment;
receive network information at the user equipment during the registration update process, during the handover, or during the state transition of the user equipment; and
establish a connection between the user equipment and the local network based on the network information.

34-64. (canceled)
